(19) United States
(12) Patent Application Publication
(10) Pub. No.: US 2008/0282153 A1
(43) Pub. Date: Nov. 13, 2008

(54) TEXT-CONTENT FEATURES

(75) Inventors: Susanne Charlotte Kindeberg, Lund (SE); Bodil Bennheden Veige, Molle (SE); Simon Daniel Ekstrand, Eslov (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/746,194

(22) Filed: May 9, 2007

(51) Int. Cl. G06F 17/00; G06F 17/27

(52) U.S. Cl. 715/256; 715/243; 704/9

(57) ABSTRACT

A device that may include logic to determine whether each word in a text is important to convey a content of the text, logic to emphasize each word determined to be important, and logic to reduce spacing between lines of text.

### BACKGROUND

1. Description of Related Art

The proliferation of devices, such as hand-held, portable, stationary, and mobile devices, has grown tremendously within the past decade. Given the technological advances of recent years, communication and information exchange has been redefined. With the development of multi-functional devices, coupled with anywhere, anytime connectivity, today's users are afforded an expansive platform to communicate with one another. In turn, our reliance on such devices has comparatively grown in both personal and business settings.

While our enhanced ability to communicate provides us with many benefits, users are sometimes hampered with the volume of information that they may receive. In particular, the frequency and amount of text a user may receive or gather (e.g., e-mail messages, short messaging service (SMS) messages, multimedia messaging service (MMS) messages, web pages) during any given day may be overwhelming. Although a user may enjoy reading text (e.g., a news article) on his/her device, the process of reading text may be cumbersome because of the length of the news article, the size of a display of the device, the need for scrolling, etc. Accordingly, information overflow combined with limited time may cause a user to intentionally or unintentionally overlook important information.

### SUMMARY

According to one aspect, a device may include logic to determine whether each word in a text is important to convey a content of the text, logic to emphasize each word determined to be important, logic to de-emphasize each word determined to be important, and logic to reduce spacing between lines of text.

Additionally, the logic to determine may determine based on at least one of grammar and syntax information, or user history information.

Additionally, the logic to emphasize may include logic to modify each character of each important word so that each important word is more visually conspicuous than each unimportant word.

Additionally, the logic to de-emphasize may include logic to modify each character of each unimportant word so that each unimportant word is less visually conspicuous than each important word.

Additionally, the logic to determine may include logic to extract text from a document having both text and non-text.

According to another aspect, a device may include logic to identify words in a text that provide a comprehensive overview of the text, logic to visually emphasize each identified word, logic to reduce a size of non-text, and a display to display the text and the non-text, where the text may include the identified words and non-identified words.

Additionally, the logic to determine may include logic to convert one file format to another file format.

Additionally, the logic to determine may include logic to parse the text into smaller textual units, the smaller textual units may include at least one of a paragraph, a sentence, a phrase, or a word.

Additionally, the logic to determine may include logic to assign a corresponding weight to each parameter used to determine if each word is an identified word, and logic to compare a total weight of each word to a threshold value.

Additionally, the logic to emphasize may emphasize based on user preference information.

Additionally, the logic to reduce may reduce based on device profile information that includes the number of lines of text displayable on the display.

Additionally, the device may include logic to arrange non-text at an end of a page or a document.

Additionally, the device may include logic to reduce spacing between lines of text.

According to a further aspect, a method may include determining whether each word of a text is important so as to convey a comprehensive overview of the text, emphasizing each word determined to be important, de-emphasizing each word determined to be unimportant, reducing spacing between lines of text, and displaying the emphasized and the de-emphasized words of the text, where the emphasized words may be visually more conspicuous than the deemphasized words.

According to yet another aspect, a method may include identifying whether a word of a text is important, emphasizing the word if the word is determined to be important, reducing spacing between lines of text, and storing the text having important words emphasized.

Additionally, the method may include reducing a size of non-text.

Additionally, the method may include arranging non-text to a bottom of a page or a document.

Additionally, emphasizing may include at least one of highlighting a background of each important word, or animating each important word.

Additionally, the method may include omitting non-text.

Additionally, emphasizing may include vocalizing with an automated voice each important word comparatively louder than each unimportant word.

Additionally, where vocalizing may include vocalizing each important word comparatively slower than each unimportant word.

According to still another aspect, a computer-readable medium may have stored thereon sequences of instructions which, when executed by at least one processor may cause the at least one processor to determine whether each word in a text is important to convey a comprehensive overview of the text, emphasize each word determined to be important, reduce spacing between lines of text, and display each important word and each unimportant word.

According to another aspect, a device may include means for determining whether each word in a text is important to convey a content of the text, means for emphasizing each word determined to be important, means for reducing spacing between lines of text, means for reducing a size of non-text, and means for displaying the non-text and the text, where each word of the text is displayed.

### BRIEF DESCRIPTION OF THE DRAWINGS

The accompanying drawings, which are incorporated in and constitute a part of this specification, illustrate exemplary embodiments described herein and, together with the description, explain these exemplary embodiments. In the drawings:

FIG. 1 is a diagram of an exemplary portable device with text-content features;

FIG. 2 is a diagram of exemplary components of the portable device of FIG. 1;

FIG. 3 depicts a flow chart of an exemplary process for converting text to text having text-content features; and

FIG. 4 is a diagram illustrating a comparison between original text and text having text-content features.

### DETAILED DESCRIPTION

The following detailed description refers to the accompanying drawings. The same reference numbers in different drawings may identify the same or similar elements. Also, the following detailed description does not limit the invention.

### Overview

Implementations described herein provide a device having text-content features that assist a user in ascertaining the content of text more quickly without omitting any of the original text. In one implementation, any word of text may be categorized as being important or not important (i.e., important or unimportant to convey a comprehensive overview of the text). Words determined to be important may be made more visually conspicuous than unimportant words. Various techniques may be employed in determining whether a word is important or not important, as well as making words more or less visually conspicuous. “Word”, as used herein, may include any string of one or more characters (e.g., letters, numbers, and/or symbols).

In this way, a user may be able to understand the gist of the text more readily by more easily identifying and reading the important words of the text. In addition, text having text content features may allow more text to, for example, be displayed on a display screen of a device. That is, for example, if unimportant words are reduced in font size to make them less conspicuous to the user, more text may be displayed since vertical space may be saved. Further, text having text-content features may minimize unnecessary spacing between lines of text (e.g., between paragraphs, between lines of text within a paragraph) and/or reduce the size of non-text. Thus, a user may be able to peruse the entire text more quickly because scrolling may be minimized.

The description to follow will describe an exemplary device and method including text-content features. In practice, implementations of a device and/or method may include, for example, hardware, software, combinations of hardware and software, or hybrid architectures, in order to realize text-content features.

### Exemplary Text-Content Device

### Exemplary Device

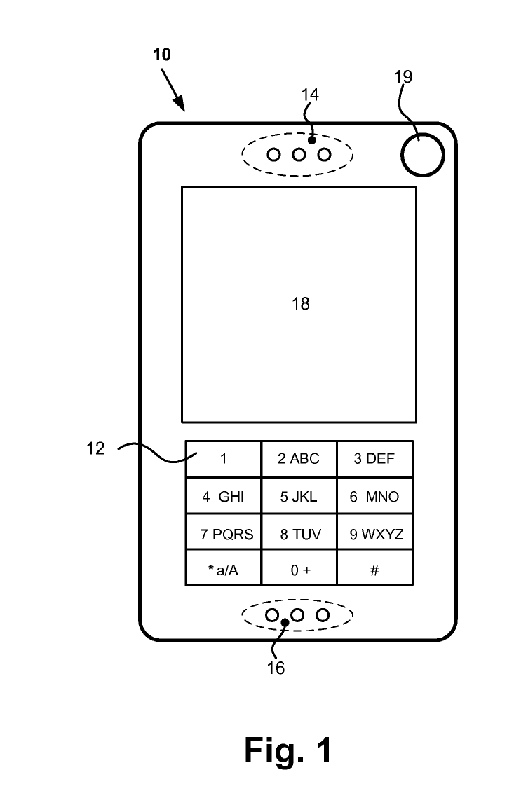

FIG. 1 illustrates an exemplary device 10. As illustrated in FIG. 1, device 10 may include keypad 12, speaker 14, microphone 16, display 18, and camera 19. FIG. 1 illustrates exemplary external components of device 10. Accordingly, device 10 may include fewer, additional, or different external components. The external components of device 10 may be arranged differently than those illustrated in FIG. 1. In addition, the external components of device 10 may include other functional/operational/structural features than those exemplarily described below.

For discussion purposes only, consider device 10 as a portable device, such as a mobile phone. In other implementations, device 10 may be any other type of, for example, communication, computation, image capturing and/or audio-visual (AV) player/recorder device.

Keypad 12 may include any component capable of providing input to device 10. As illustrated in FIG. 1, keypad 12 may include a standard telephone keypad and/or a set of function keys. The buttons of keypad 12 may be pushbuttons, touch-buttons, and/or a combination of different suitable button arrangements. A user may utilize keypad 12 for entering information, such as selecting functions and responding to prompts.

Speaker 14 may include any component capable of providing sound to a user. Microphone 16 may include any component capable of sensing sound of a user.

Display 18 may include any component capable of providing visual information to a user. Display 18 may be utilized for presenting text, images, and/or video to a user. Camera 19 may include any component capable of capturing an image. Display 18 may be utilized for presenting an image captured by camera 19. An antenna (not illustrated) may be built internally into device 10, and hence is not illustrated in FIG. 1. Device 10 may provide information exchange to other users via a network (not illustrated).

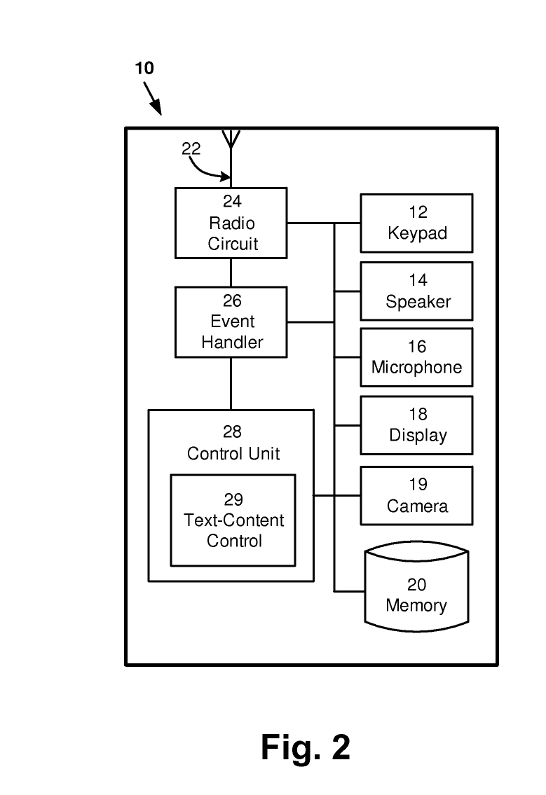

FIG. 2 illustrates exemplary internal components of device 10. As illustrated in FIG. 2, device 10 may include keypad 12, speaker 14, microphone 16, display 18, camera 19, memory 20, antenna 22, radio circuit 24, event handler 26, control unit 28, and text-content control 29. No further discussion relating to components previously described in FIG. 1 is provided. FIG. 2 illustrates exemplary internal components of device 10. Accordingly, device 10 may include fewer, additional, or different internal components. The internal components of device 10 may be arranged differently than those illustrated in FIG. 2. In addition, the internal components of device 10 may include other functional/operational/structural features than those exemplarily described below.

Memory 20 may include any type of storage component. For example, memory 20 may include a random access memory (RAM), a read only memory (ROM), a programmable read only memory (PROM), a hard drive, or another type of computer-readable medium. The computer-readable medium may be any component that stores (permanently, transitorily, or otherwise) information readable by a machine. A computer-readable medium may include one or more memory devices and/or carrier waves. The computer-readable medium may be removable. Memory 20 may store data and instructions related to the operation and use of device 10.

Antenna 22 and radio circuit 24 may include any component for enabling radio communication with, for example, a network or another device.

Event handler 26 may include any component for administrating events, such as incoming and outgoing information exchange to and from, for example, a network.

Control unit 28 may include any processing logic that may interpret and execute instructions. “Logic”, as used herein may include hardware (e.g., an application specific integrated circuit (ASIC), a field programmable gate array (FPGA)), software, a combination of software and hardware, or hybrid architecture. Control unit 28 may include, for example, a microprocessor, a data processor, and/or a network processor. Instructions used by control unit 28 may also be stored in a computer-readable medium accessible by or provided within control unit 28. The computer-readable medium may include one or more memory devices and/or carrier waves. Control unit 28 may control the operation of device 10 and its components.

Text-content control 29 may include any logic that performs text-content features, as described herein. In practice, text-content control 29 may be implemented employing hardware, software, a combination of hardware and software, and/or hybrid architecture. Instructions used by text-content control 29 may also be stored in a computer-readable medium accessible by or provided within text-content control 29. The computer-readable medium may include one or more memory devices and/or carrier waves. For example, any readable medium (e.g., a memory stick, a compact disc) for a device and/or a computer may be employed. The program code may also be downloaded, for example, from another entity, such as a network, to which device 10 may be connected.

It is to be understood that text-content control 29 may be implemented in a number of ways to achieve text having text-content features. Accordingly, the implementations described below are exemplary in nature, and fewer, additional, or different components and/or processes may be employed to realize text having text-content features. Additionally, the implementations described below are not restricted to the order in which they have been described below.

In one implementation, text-content control 29 may access text from another component of device 10, such as memory 20 or event handler 26. In another implementation, text-content control 29 may access text on a data card (e.g., a subscriber identification module (SIM) card, user identification module (UIM))(not illustrated), on a USB flash drive (not illustrated), or some other external device.

Text-content control 29 may convert original text included in a variety of file formats (e.g., .html, .doc, .pdf, .jpg, .tif, .gif, .txt) and layouts (e.g., only text, text and images, text, images, and animation) to text having text-content features. In one implementation, for example, text-content control 29 may convert one or more file formats to another in order to provide text having text-content features. Alternatively, or additionally, for example, text-content control 29 may extract text from a file in order to provide text having text-content features.

Text-content control 29 may categorize each word of text. In one implementation, for example, each word in the text may be categorized as being important or unimportant (i.e., important or not important to convey a comprehensive overview of the text). Thus, for example, text-content control 29 may determine whether a word is important or unimportant. In one implementation, text-content control 29 may parse the text. For example, text-content control 29 may parse the text into paragraphs, sentences, phrases, words, and/or another type of textual unit. In addition, for example, text-content control 29 may identify each word as a subject, a verb, an adjective, a preposition, a noun, an adverb, a stop word (e.g., it, a, the), etc. Text-content control 29 may refer to information (e.g., a database, program code) that identifies important words and unimportant words. In one implementation, for example, the database may include a dictionary, and the program code may include information relating to grammar and/or syntax, and/or other rules (e.g., frequency of word in original text, highlighting of a word in original text (e.g., italicizing, underlining, and/or bolding). Alternatively, or additionally, information, such as user word history (e.g., words spoken into microphone 16 during a previous phone call, words inputted via keypad 12 of a previous text message sent to a friend) may determine important words and unimportant words.

In one implementation, for example, various parameters associated with a word may be assigned a corresponding weight value. For example, text-content control 29 may parse the text and identify a word as being the subject in a sentence. Text-content control 29 may assign a positive weight value to this word. Alternately, for example, text-content control 29 may parse the text and identify a word as being a “stop” word (e.g., a, the, it). Text-content control 29 may assign a negative weight value to this word. Also, text-content control 29 may determine that a word is highlighted and/or underlined. Text-content control 29 may assign a positive weight value to this word. Thus, for example, if the total weight value of a word is equal to, or above a threshold value, text-content control 29 may determine that the word is important.

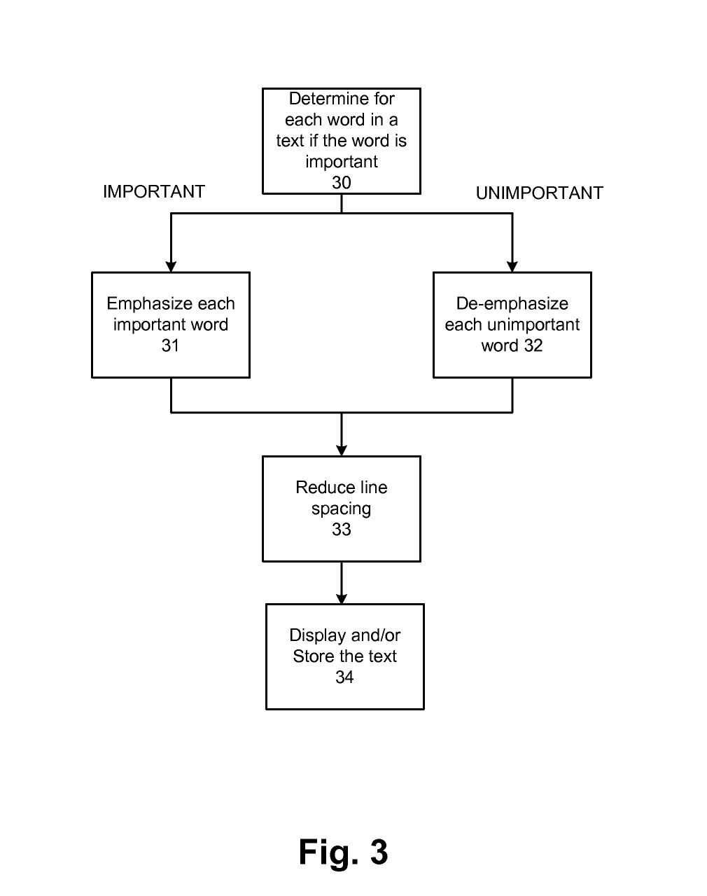

Text-content control 29 may emphasize and/or de-emphasize each word of text. In one implementation, for example, text-content control 29 may emphasize important words. Alternatively, or additionally, for example, text-content control 29 may de-emphasize unimportant words. In one implementation, for example, text-content control may refer to device profiler information (e.g. resolution of display 18 or number of lines of text displayable on display 18) when emphasizing and/or de-emphasizing a word. In one implementation, since by virtue of making unimportant words less conspicuous, important words may be made more conspicuous, text-content control 29 may only de-emphasize unimportant words. Similarly, in another implementation, since by virtue of making important words more conspicuous, unimportant words may be made less conspicuous, text-content control 29 may only emphasize important words. In yet another implementation, unimportant words may be made less conspicuous and important words may be made more conspicuous. Thus, text-content control 29 may emphasize and/or de-emphasize important words and unimportant words, respectively. Various techniques for emphasizing a word (i.e., making a word more conspicuous) and deemphasizing a word (i.e., making a word less conspicuous) may be employed, as described in greater detail with reference to an exemplary process of FIG. 3.

Text-content control 29 may optimize the presentation of text having text-content features. In one implementation, for example, text-content control 29 may optimize the original spacing and arrangement of text and/or non-text (e.g., pictures, animated icons). For example, in one implementation, text-content control 29 may reduce spacing between lines of text (e.g., spacing between paragraphs and/or spacing between lines of text within a paragraph). Alternatively, or additionally, for example, text-content control 29 may omit and/or reduce nontext (e.g., pictures, animated icons) to provide more space for the text having text-content features to be, for example, displayed on display 18. In another implementation, for example, text-content control 29 may re-arrange non-text-content to the end of a document, so that text having text-content features may be arranged at the beginning of the document. For example, in one implementation, text-content control 29 may utilize pointers or addresses in order to adjust spacing and arrangement of text having text-content features and/or non-text. Alternatively, or additionally, for example, text-content control 29 may determine the space and arrangement of text having text-content features and/or non-text based on device profiler information (e.g., number of text lines displayable on display 18).

In one implementation, a user of device 10 may display text having text-content features on display 18 for reading purposes. In another implementation, a user of device 10 may store text having text-content features for later retrieval and use. In another implementation, a text-to-speech unit (not illustrated) may be employed to read the text having text-content features. For example, in one implementation, important words may be spoken louder and slower (by an automated voice) than unimportant words, which may be spoken softer and faster (by the automated voice).

### Exemplary Text-Content Method

### Exemplary Method

FIG. 3 depicts a flow chart of an exemplary process for converting original text to text having text-content features. For purposes of discussion, assume that a user of device 10 has accessed a document having only text information.

### Block 30

Determine for each word in a text if the word is important. In one implementation, for example, each word may be categorized as being important or unimportant (i.e., important or not important to convey a comprehensive overview of the text). By virtue of determining whether a word is important, unimportant words may be determined. In another implementation, for example, text-content control 29 may determine whether a word is unimportant, and by virtue of such determination, important words may be determined.

### Block 31

Emphasize each important word. An important word may be made more conspicuous by making unimportant words less conspicuous, making important words more conspicuous, or making both important words more conspicuous and unimportant words less conspicuous. In one implementation, for example, the font size of the words may be adjusted accordingly (e.g., increase font size for important words and/or decrease font size for unimportant words). In other implementations, bolding, underlining, altering the color of the font, altering the style of the font, altering the surrounding background color (e.g., highlighting), and/or animating important words with movement may be employed so that a user may easily read the important words of the text. In this way, the user of device 10 may more rapidly and with more ease get a general grasp/overview of the text without perusing in detail each and every word of the text.

The visual aspects associated with making a word more conspicuous may be adjustable by the user. For example, if the user is color blind, the use of color may have little effect in making an important word more conspicuous. Conversely, for example, the user may be able to select a favorite color or font style that makes an important word more conspicuous. Thus, text-content control 29 may allow the user flexibility in designing and customizing the visual presentation of the important words of the text.

### Block 32

De-emphasize each unimportant word. An unimportant word may be made less conspicuous by making important words more conspicuous, making unimportant words less conspicuous, or making both important words more conspicuous and unimportant words less conspicuous. In one implementation, for example, the font size of the words may be adjusted accordingly (e.g., increase font size for important words and/or decrease font size for unimportant words). In other implementations, lightening, altering the color of the font, altering the style of the font, and/or altering the surrounding background color may be employed so that the user's focus on unimportant words may be significantly reduced. In this way, the user may more rapidly and with more ease get a general grasp/overview of the text without perusing in detail each word of the text.

The visual aspects associated with making a word less conspicuous may be adjustable by the user. For example, if the user is color blind, the use of color may have little effect in making an unimportant word less conspicuous. Conversely, for example, the user may be able to select a particular color or font style that makes an unimportant word less conspicuous. Thus, text-content control 29 may allow the user flexibility in designing and customizing the visual presentation of the unimportant words of the text.

### Block 33

Reduce line spacing. In one implementation, line spacing between paragraphs may be reduced. Alternatively, or additionally, line spacing between lines of text within a paragraph may be reduced. Text-content control 29 may refer to device profile information to reduce spacing.

### Block 34

Display and/or Store text. In one implementation, the user may have the text having text-content features displayed on display 18 of device 10. In another implementation, the user may have text having text-content features stored for later retrieval and use. For example, the user may print the text having text-content features, or use a text-to-speech unit that reads the text having text-content. Alternatively, a user may scan a document into a device (e.g., a device not having a display), and the device may convert the original text of the document to text having text-content features. A user may then print a document having text-content features.

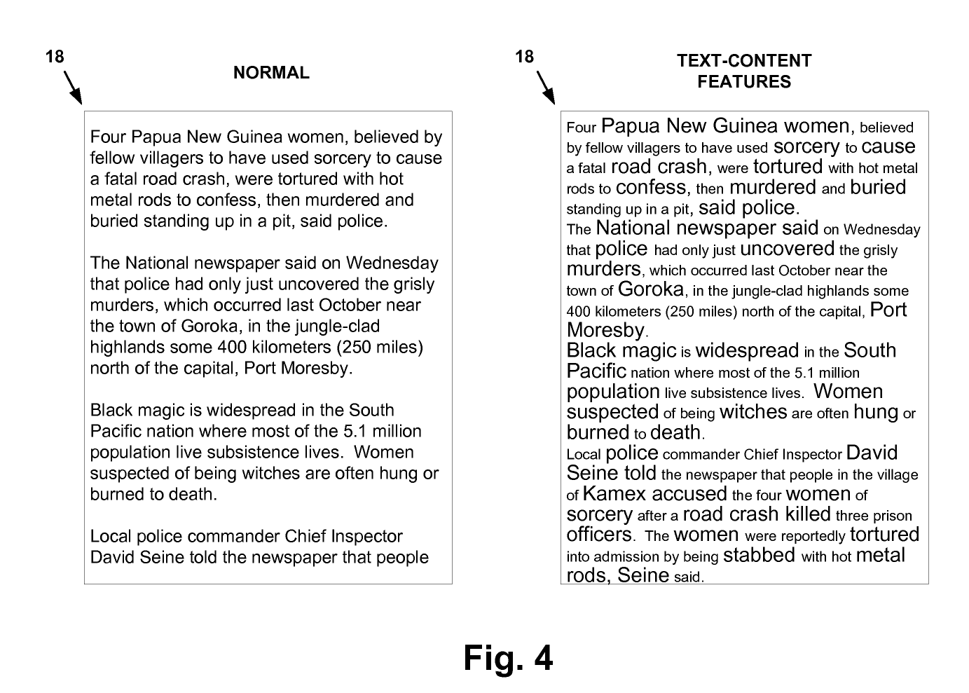

FIG. 4 is a diagram illustrating a comparison between original text and text including text-content features. For discussion purposes only, assume that the comparison is being made on display 18 of device 10.

FIG. 4 illustrates an exemplary news article that a user has decided to read on device 10. In FIG. 4, normal exemplarily represents original text of the news article as would be displayed on display 18. Also, in FIG. 4, text-content features exemplarily represent text having text-content features of the news article as would be displayed on display 18. In this example, the font size for both unimportant words and important words of the news article has been decreased and increased, respectively. In addition, unnecessary spacing between paragraphs has been removed.

A user of device 10 wishing to read the text having text-content features of the news article on display 18 may ascertain the gist of the news article much more quickly. For example, the user may easily identify the important words of the news article. In addition, the user may be able to read all of the important words of the news article without the need to scroll. Furthermore, the user, if he/she desires, may read the entire article in detail (i.e., read both unimportant words and important words) since nothing from the original text of the news article has been deleted.

### Conclusion

Implementations described herein may provide text having text-content features. A user may obtain a comprehensive overview of text, either visually (e.g., reading the text) or auditorily (e.g., utilizing a text-to-speech unit that recognizes the emphasis and/or de-emphasis of words), without omitting any of the original text.

The foregoing description of exemplary embodiments provides illustration and description, but is not intended to be exhaustive or to limit the invention to the precise form disclosed. Modifications and variations are possible in light of the above teachings or may be acquired from practice of the invention.

For example, while a series of blocks have been described with regard to FIG. 3, the order of the blocks may be modified in other implementations. For example, the reducing line spacing block may be before the determining for each word in a text if the word is important block. Further, non-dependent blocks may be performed in parallel. For example, the determining and reducing blocks may be performed in parallel.

It should be emphasized that the term “comprises” or “comprising” when used in the specification is taken to specify the presence of stated features, integers, steps, or components but does not preclude the presence or addition of one or more other features, integers, steps, components, or groups thereof.

It will be apparent that aspects, as described above, may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware could be designed to implement these aspects based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A device, comprising:
logic to determine whether each word in a text is important to convey a content of the text;
logic to emphasize each word determined to be important;
logic to de-emphasize each word determined to be unimportant; and
logic to reduce spacing between lines of text.

2. The device of claim 1, wherein the logic to determine determines based on at least one of grammar and syntax information, or user history information.

3. The device of claim 1, wherein the logic to emphasize comprises:
logic to modify each character of each important word so that each important word is more visually conspicuous than each unimportant word.

4. The device of claim 1, wherein the logic to de-emphasize comprises:
logic to modify each character of each unimportant word so that each unimportant word is less visually conspicuous than each important word.

5. The device of claim 1, wherein the logic to determine comprises:
logic to extract text from a document having both text and non-text.

6. A device, comprising:
logic to identify words in a text that provide a comprehensive overview of the text;
logic to visually emphasize each identified word;
logic to reduce a size of non-text; and
a display to display the text, wherein the text includes the identified words and non-identified words.

7. The device of claim 6, wherein the logic to determine comprises:
logic to convert one file format to another file format.

8. The device of claim 6, wherein the logic to determine comprises:
logic to parse the text into smaller textual units, the smaller textual units being at least one of a paragraph, a sentence, a phrase, or a word.

9. A device of claim 6, wherein the logic to determine comprises:
logic to assign a corresponding weight to each parameter used to determine if each word is an identified word; and
logic to compare a total weight of each word to a threshold value.

10. The device of claim 6, wherein the logic to emphasize emphasizes based on user preference information.

11. The device of claim 6, wherein the logic to reduce reduces based on device profile information that includes the number of lines of text displayable on the display.

12. The device of claim 6, further comprising:
logic to arrange non-text at an end of a page or a document.

13. The device of claim 6, further comprising:
logic to reduce spacing between lines of text.

14. A method, comprising:
determining whether each word of a text is important so as to convey a comprehensive overview of the text;
emphasizing each word determined to be important;
de-emphasizing each word determined to be unimportant;
reducing spacing between lines of text; and
displaying the emphasized and the de-emphasized words of the text, wherein the emphasized words are visually more conspicuous than the de-emphasized words.

15. A method, comprising:
identifying whether a word of a text is important;
emphasizing the words if the word is determined to be important;
reducing spacing between lines of text; and
storing the text having important words emphasized.

16. The method of claim 15, further comprising:
reducing a size of non-text.

17. The method of claim 15, further comprising:
arranging non-text to a bottom of a page or a document.

18. The method of claim 15, wherein emphasizing comprises at least one of:
highlighting a background of each important word; or animating each important word.

19. The method of claim 15, further comprising:
omitting non-text.

20. The method of claim 15, wherein emphasizing comprises:
vocalizing with an automated voice each important word comparatively louder than each unimportant word.

21. The method of claim 20, wherein vocalizing comprises:
vocalizing each important word comparatively slower than each unimportant word.

22. A computer-readable medium having stored thereon sequences of instructions which, when executed by at least one processor causes the at least one processor to:
determine whether each word in a text is important to convey a comprehensive overview of the text;
emphasize each word determined to be important;
reduce spacing between lines of text; and
display each important word and each unimportant word.

23. A device, comprising:
means for determining whether each word in a text is important to convey a content of the text;
means for emphasizing each word determined to be important;
means for reducing spacing between lines of text;
means for reducing a size of non-text; and
means for displaying the important words and the unimportant words, wherein each word of the text is displayed.
